(19) United States
(12) Patent Application Publication
(10) Pub. No.: US 2025/0299326 A1
(43) Pub. Date: Sep. 25, 2025

(54) CELL ENUMERATION MODULE FOR SECRETION SORTING

(71) Applicants: Sony Corporation of America, New York, NY (US); SONY GROUP CORPORATION, Tokyo (JP)

(72) Inventors: Su-Hui Chiang, San Jose, CA (US); Thanh Chau Nguyen, San Jose, CA (US); Haipeng Tang, Sunnyvale, CA (US); Michael Zordan, Boulder Creek, CA (US); Ko-Kai Albert Huang, Saratoga, CA (US); Ming-Chang Liu, San Jose, CA (US)

(21) Appl. No.: 18/957,396

(22) Filed: Nov. 22, 2024

Related U.S. Application Data
(60) Provisional application No. 63/567,986, filed on Mar. 21, 2024.

(51) Int. Cl. G06T 7/00

(52) U.S. Cl. CPC G06T 7/0012; G06T 2207/10056; G06T 2207/20081; G06T 2207/20084; G06T 2207/30024

(57) ABSTRACT

Methods, systems, and devices for enumerating the number of cells present in each event for cell-secretion based sorting applications are described herein. The cell secretion applications use carrier to encapsulate cells and collect the biomolecules they secrete. The carriers are then sorted using flow based particle sorting. The total number of cells present in a carrier is very important for several applications. A convolutional neural network is used to count the number of cells present from a brightfield image, and outputs the information to be used as part of the sort logic.

### CROSS-REFERENCE TO RELATED APPLICATION(S)

This application claims priority under 35 U.S.C. § 119 (e) of the U.S. Provisional Patent Application Ser. No. 63/567,986, filed Mar. 21, 2024 and titled, “CELL ENUMERATION MODULE FOR SECRETION SORTING,” which is hereby incorporated by reference in its entirety for all purposes.

### FIELD OF THE INVENTION

The present invention relates to cell sorting. More specifically, the present invention relates to image-based cell sorting.

### BACKGROUND OF THE INVENTION

Cells secrete products such as proteins and antibodies. The study of these secreted products (secretome) has been revolutionary for the understanding of cellular biology. The analysis and purification of cells that secrete specific biomolecules is required to produce biologic drugs like antibody therapies. Improving the ability to analyze and purify cells based on their secreted products will accelerate the development of the next generation of cell and antibody therapies.

In secretion-based sorting, cells are clonally isolated, and the secreted products are contained. Previously, the work used multi-well plates, which required expertise and expensive dedicated equipment.

### SUMMARY OF THE INVENTION

Methods, systems, and devices for enumerating the number of cells present in each event for cell-secretion based sorting applications are described herein. The cell secretion applications use carriers to encapsulate cells and collect the biomolecules they secrete. The carriers are then sorted using flow based particle sorting. The total number of cells present in a carrier is very important for several applications. A convolutional neural network is used to count the number of cells present from a brightfield image, and outputs the information to be used as part of the sort logic.

In one aspect, a method comprises receiving a plurality of cell images, wherein each cell image of the plurality of cell images contains a carrier, counting a number of cells in each carrier in each cell image of the plurality of cell images, classifying each of the cell images based on the number of cells in each carrier and classifying each of the cell images based on detected secretion information. The plurality of cell images are brightfield images. The method further comprises training a neural network to classify cell images based on counting the number of cells in each carrier, and training the neural network to classify the cell images based on secretion information. The method further comprises retaining only the cell images classified as having a single cell in each carrier. Classifying each of the cell images based on the detected secretion information includes a “no secretion” classification, a “low secretion” classification, and a “high secretion” classification. Classifying each of the cell images based on the detected secretion information includes retaining only images with a “high secretion” classification. Classifying each of the cell images based on the number of cells in each carrier and classifying each of the cell images based on the detected secretion information occur in parallel. The carrier comprises a double emulsion.

In another aspect, an apparatus comprising: a non-transitory memory for storing an application, the application for: receiving a plurality of cell images, wherein each cell image of the plurality of cell images contains a carrier, counting a number of cells in each carrier in each cell image of the plurality of cell images, classifying each of the cell images based on the number of cells in each carrier and classifying each of the cell images based on detected secretion information and a processor coupled to the memory, the processor configured for processing the application. The plurality of cell images are brightfield images. The application is further for training a neural network to classify cell images based on counting the number of cells in each carrier, and training the neural network to classify the cell images based on secretion information. The application is further for retaining only the cell images classified as having a single cell in each carrier. Classifying each of the cell images based on the detected secretion information includes a “no secretion” classification, a “low secretion” classification, and a “high secretion” classification. Classifying each of the cell images based on the detected secretion information includes retaining only images with a “high secretion” classification. Classifying each of the cell images based on the number of cells in each carrier and classifying each of the cell images based on the detected secretion information occur in parallel. The carrier comprises a double emulsion.

In another aspect, a system comprising: a first device configured for acquiring a plurality of cell images and a second device configured for: receiving a plurality of cell images, wherein each cell image of the plurality of cell images contains a carrier, counting a number of cells in each carrier in each cell image of the plurality of cell images, classifying each of the cell images based on the number of cells in each carrier and classifying each of the cell images based on detected secretion information. The plurality of cell images are brightfield images. The second device is further for training a neural network to classify cell images based on counting the number of cells in each carrier, and training the neural network to classify the cell images based on secretion information. The second device is further for retaining only the cell images classified as having a single cell in each carrier. Classifying each of the cell images based on the detected secretion information includes a “no secretion” classification, a “low secretion” classification, and a “high secretion” classification. Classifying each of the cell images based on the detected secretion information includes retaining only images with a “high secretion” classification. Classifying each of the cell images based on the number of cells in each carrier and classifying each of the cell images based on the detected secretion information occur in parallel. The carrier comprises a double emulsion.

### BRIEF DESCRIPTION OF THE DRAWINGS

FIG. 1 illustrates an image of carriers with varying numbers of cells according to some embodiments.

FIG. 2 illustrates a graph of seeding of carriers according to some embodiments.

FIG. 3 illustrates an exemplary Convolutional Neural Network (CNN) implementing the cell enumeration module according to some embodiments.

FIG. 4 shows a block diagram of an exemplary computing device configured to implement the cell enumeration according to some embodiments.

FIG. 5 illustrates a flowchart of a method of cell enumeration for secretion sorting according to some embodiments.

FIG. 6 illustrates a diagram schematically showing the overall configuration of a biological sample analyzer according to some embodiments.

### DETAILED DESCRIPTION OF THE PREFERRED EMBODIMENT

The cell enumeration module for secretion sorting described herein is related to U.S. Patent Application No. *Atty. Docket No. Sony-77900*, filed ***, and titled “EXTENSION OF IACS FRAMEWORK TO SECRETOME APPLICATIONS” and U.S. Patent Application No. *Atty. Docket No. Sony-78000*, filed ***, and titled “AUTOMATIC ANNOTATION OF EVENT TYPES IN IACS WORKFLOW,” both of which are incorporated by reference in their entireties for all purposes.

Methods, systems, and devices for enumerating the number of cells present in each event for cell-secretion based sorting applications are described herein. The cell secretion applications use carriers to encapsulate cells and collect the biomolecules they secrete. The carriers are then sorted using flow based particle sorting. The total number of cells present in a carrier is very important for several applications. A convolutional neural network is used to count the number of cells present from a brightfield image, and outputs the information to be used as part of the sort logic.

Secretion-based applications will often have a specific number of cells be present in a carrier. The most common criteria is that only a single cell is present in the carrier such as monoclonal antibody production. Secretion-based sorting has been performed on conventional flow cytometers, but there is not an effective way to count the cells inside the carrier, so the sorting product may contain events with multiple cells. There is not a good method to address this after a sort, so currently carriers are underseeded with cells to reduce the amount of carriers that have multiple cells, limiting the loading efficiency to roughly 10%. The ability to count the number of cells in a carrier from a brightfield image ensures that the sorted product will have the desired number of cells. Additionally, being able to exclude events with multiple cells will greatly increase the efficiency of the experiments because the carriers can be seeded at a greater density which will result in a greater percentage (e.g., approximately 40%) of carrier that contain the desired number of cells.

The embodiments described herein are implemented as part of an image-based cell sorter. The implementations are included in a module that runs parallel to the clustering and real-time classification framework, and the output is used to filter out events that do not contain the desired number of cells. Embodiments are able to be applied to other cell sorting applications that use imaging including fluorescence localization, morphology based cell sorting and the sorting of cell: cell interaction complexes.

Carriers have been used for secretion-based sorting using conventional cell sorters such as the Sony SH800. However, conventional cell sorters do not measure spatial information, only scatter and fluorescence intensity. The fluorescence signals can be used to identify events with the desired secretion profile, but there has not been an effective way to count the number of cells present in the carrier.

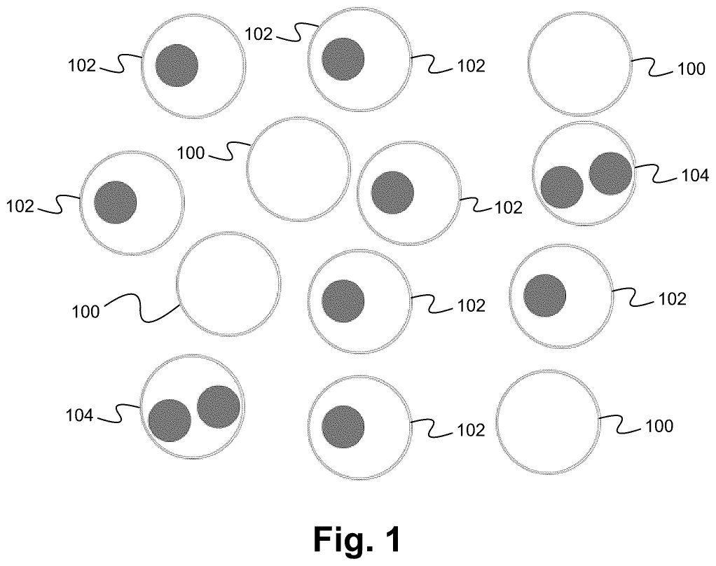

FIG. 1 illustrates an image of carriers with varying numbers of cells according to some embodiments. Empty carriers 100 contain zero cells. Carriers 102 contain a single cell. Carriers 104 contain multiple cells (e.g., two or more cells).

As described, many secretion-based sorting applications use sorted carriers containing a specific number of cells (e.g., a single cell). Carriers are loaded with cells in bulk solution, where the number of cells seeded follows the Poisson distribution.

Seeding of carriers includes placing carriers in a flask or other container, waiting for a set period of time (e.g., 30 minutes) for the openings of the carriers to orient upward and settle to the bottom, and then cells are put in the flask/container to drop in to the carriers. The seeding density or how many cells go into each carrier is controlled by adjusting the concentration of cells put into the flask/container which follows a Poisson density seeding process. Previously, the carriers were seeded at a low level to avoid multiple cells in a single carrier. This resulted in the vast majority of carriers (approximately 89%) having no cells in a carrier, and approximately 11% of the carriers had at least one cell, since there was no process to get rid of events that have multiple cells in a single carrier.

Brightfield images are the most effective way to count the number of cells present in a carrier because it detects cells without a fluorescent signal which would be missed on a conventional cell sorter. In some embodiments, a different type of image is utilized for cell counting.

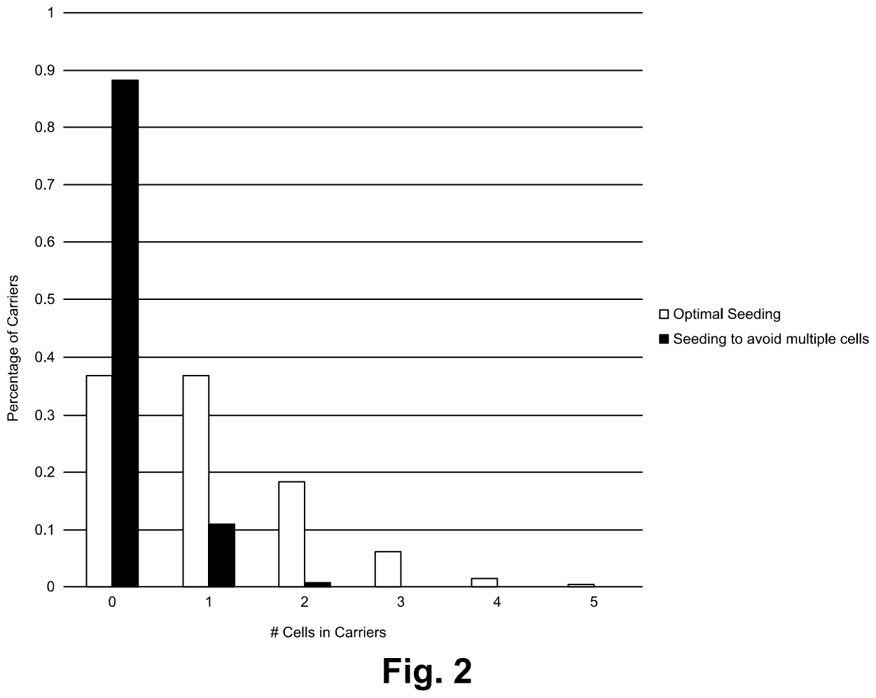

FIG. 2 illustrates a graph of seeding of carriers according to some embodiments. Experiments are able to be performed to sort carriers, and the throughput is based on carriers/second that can be sorted. Previously, cells were underseeded to avoid multiple cells in the same carrier so only approximately 11% contain a single cell and the vast majority are empty. The ability to exclude events with multiple cells means that cells can be seeded at a higher density, with a theoretical amount of 38% containing a single cell. Increased cell loading efficiency means that fewer total carriers are needed to screen the same number of cells so optimal cell loading will result in at least three times throughput.

In the graph, the y-axis is the percentage of carriers, and the x-axis is the number of cells per carrier. As described, the previous implementation seeded to avoid multiple cells which resulted in approximately 89% of the carriers having zero cells, and only approximately 11% of the carriers having a single cell. With optimal seeding, approximately 38% of the carriers have zero cells, and approximately 38% of the carriers have a single cell. Therefore, by utilizing optimal seeding and being able to identify carriers with a single cell, more efficient experiments are able to be implemented, since the carriers with zero cells and two or more cells are able to be eliminated.

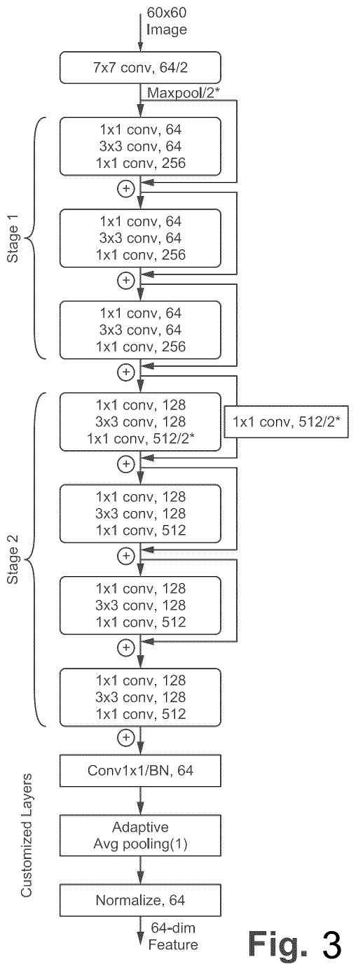

FIG. 3 illustrates an exemplary Convolutional Neural Network (CNN) implementing the cell enumeration module according to some embodiments. The CNN has been trained to identify the number of cells in a carrier, and is followed up by unsupervised clustering which is used to group events that contain the same number of cells (e.g., single cells). In some embodiments, the feature encoder module utilizes a CNN architecture based on ResNet50. The module adds anti-aliasing and customized layers for dimension reduction. The feature encoder has been trained to extract features relevant to the number of cells present. Image processing techniques are able to be used to extract features. For example, image processing is able to be used to detect a change in color which indicates a border of an object within an image. The image processing is also able to determine a distance of each border and/or object. Although FIG. 3 illustrates an exemplary CNN, other CNNs are able to be implemented to perform the cell enumeration.

By utilizing a cell sorter and classification system designed to perform pattern recognition, the specific pattern of antibodies detected near a target cell are able to be appropriately detected, classified and sorted. For example, a feature encoder is able to be used which is described in U.S. patent application Ser. No. 17/222,131, filed on Apr. 5, 2021, titled, “A FRAMEWORK FOR IMAGE BASED UNSUPERVISED CELL CLUSTERING AND SORTING,” which is hereby incorporated by reference in its entirety for all purposes. Additionally, the classification workflow is described in U.S. patent application Ser. No. 17/531,124, filed on Nov. 19, 2021, titled, “CLASSIFICATION WORKFLOW FOR FLEXIBLE IMAGE BASED PARTICLE SORTING,” which is hereby incorporated by reference in its entirety for all purposes.

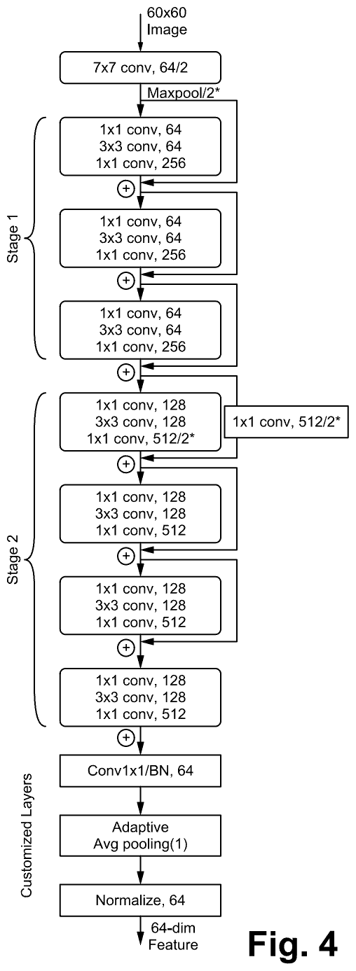

FIG. 4 shows a block diagram of an exemplary computing device configured to implement the cell enumeration according to some embodiments. The computing device 400 is able to be used to acquire, store, compute, process, communicate and/or display information such as images and videos. The computing device 400 is able to implement any of the cell enumeration aspects. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, High Definition disc/drive, ultra-HD drive, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, screen, printer, modem, touchscreen, button interface and other devices. IACS framework application(s) 430 used to implement the cell enumeration are likely to be stored in the storage device 412 and memory 404 and processed as applications are typically processed. More or fewer components shown in FIG. 4 are able to be included in the computing device 400. In some embodiments, cell enumeration hardware 420 is included. Although the computing device 400 in FIG. 4 includes applications 430 and hardware 420 for the cell enumeration, the cell enumeration is able to be implemented on a computing device in hardware, firmware, software or any combination thereof. For example, in some embodiments, the cell enumeration applications 430 are programmed in a memory and executed using a processor. In another example, in some embodiments, the cell enumeration hardware 420 is programmed hardware logic including gates specifically designed to implement the cell enumeration.

In some embodiments, the cell enumeration application(s) 430 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

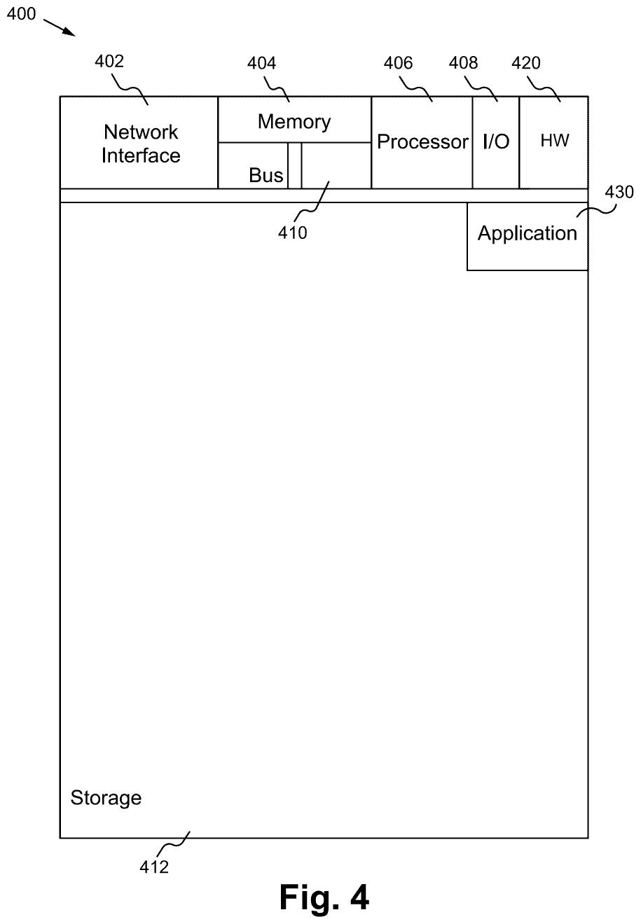

FIG. 5 illustrates a flowchart of a method of cell enumeration for secretion sorting according to some embodiments.

In the step 500, a CNN is trained. The CNN is able to be trained using images and supervised or unsupervised learning. The CNN is able to be trained to count cells in each carrier in the images and classify the images based on the cells counted. The CNN is also able to be trained to detect fluorescence biomarkers/signals in the images which are used to identify secretion amounts/profiles and classify the images based on the detected secretion information.

In the step 502, the CNN is used to count the number of cells in each carrier present in each received image, and outputs the information to be used as part of a sort logic. In some embodiments, the received images are brightfield images. The images of carriers are clustered based on the number of cells in each carrier. In some embodiments, all images of carriers containing a single cell are retained, and all other images are excluded. In some embodiments, where images contain multiple carriers per image, a process is implemented to exclude the carriers of the image that do not fit a specified criteria (e.g., a single cell in the carrier). For example, the carriers that are empty or contain 2 or more cells are deleted from the image using image processing. In another example, the image is partitioned, and only the partitions with the carriers with a single cell are retained.

In the step 504, fluorescence biomarkers/signals in the images are used to identify and label events with a desired secretion profile. The CNN or another neural network is utilized to identify and label the events based on the secretion amount. The amount of secretion is able to be classified as a “no secretion” classification, a “low secretion” classification, or a “high secretion” classification. Images are able to be sorted based on the classifications. For example, only images with a “high secretion” classification are retained.

In some embodiments, the order of the steps is modified. In some embodiments, the steps 500 and 502 occur in parallel. In some embodiments, the step 502 occurs before the step 500. For example, the images are classified by secretion, and then the images are classified by the number of cells in each carrier.

In some embodiments, fewer or additional steps are implemented. For example, carriers are seeded with cells. The seeding of carriers is able to be implemented in any manner such as placing the carriers in a container (e.g., flask), waiting for a period of time (e.g., 30 minutes) for the carriers to orient with the openings upward, and then putting cells in the container to drop into the carriers. In some embodiments, the concentration of the cells is adjusted such that a high density (e.g. 38%) of the carriers each have a single cell. Images are then acquired of the carriers with a camera or other device. In some embodiments, a feature encoder of a CNN is trained to identify the number of cells in a carrier. In some embodiments, clustering is used to group events which contain the same number of cells (e.g., single cells). In some embodiments, a feature encoder or another aspect of the CNN is trained to identify a desired secretion profile.

In some embodiments, the carrier is a double emulsion. A double emulsion is where a droplet has smaller droplets contained within them. For example, a droplet of aqueous medium containing a cell is enclosed by an oil droplet that separates the interior aqueous droplet from the bulk aqueous culture media. This is referred to as a water in oil in water (W/O/W) double emulsion.

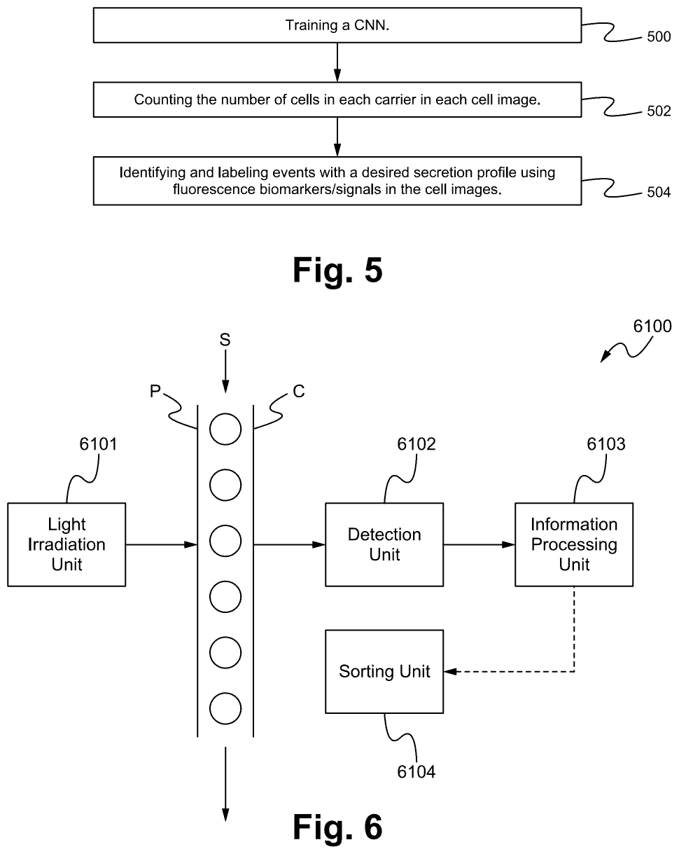

FIG. 6 illustrates a diagram schematically showing the overall configuration of a biological sample analyzer according to some embodiments.

FIG. 6 shows an example configuration of a biological sample analyzer of the present disclosure. A biological sample analyzer 6100 shown in FIG. 6 includes: a light irradiation unit 6101 that irradiates a biological sample S flowing in a flow channel C with light; a detection unit 6102 that detects light generated by irradiating the biological sample S; and an information processing unit 6103 that processes information about the light detected by the detection unit. The biological sample analyzer 6100 is a flow cytometer or an imaging cytometer, for example. The biological sample analyzer 6100 may include a sorting unit 6104 that sorts out specific biological particles P in a biological sample. The biological sample analyzer 6100 including the sorting unit is a cell sorter, for example.

### (Biological Sample)

The biological sample S may be a liquid sample containing biological particles. The biological particles are cells or non-cellular biological particles, for example. The cells may be living cells, and more specific examples thereof include blood cells such as erythrocytes and leukocytes, and germ cells such as sperms and fertilized eggs. Also, the cells may be those directly collected from a sample such as whole blood, or may be cultured cells obtained after culturing. The non-cellular biological particles are extracellular vesicles, or particularly, exosomes and microvesicles, for example. The biological particles may be labeled with one or more labeling substances (such as a dye (particularly, a fluorescent dye) and a fluorochrome-labeled antibody). Note that particles other than biological particles may be analyzed by the biological sample analyzer of the present disclosure, and beads or the like may be analyzed for calibration or the like.

### (Flow Channel)

The flow channel C is designed so that a flow of the biological sample S is formed. In particular, the flow channel C may be designed so that a flow in which the biological particles contained in the biological sample are aligned substantially in one row is formed. The flow channel structure including the flow channel C may be designed so that a laminar flow is formed. In particular, the flow channel structure is designed so that a laminar flow in which the flow of the biological sample (a sample flow) is surrounded by the flow of a sheath liquid is formed. The design of the flow channel structure may be appropriately selected by a person skilled in the art, or a known one may be adopted. The flow channel C may be formed in a flow channel structure such as a microchip (a chip having a flow channel on the order of micrometers) or a flow cell. The width of the flow channel C is 1 mm or smaller, or particularly, may be not smaller than 10 μm and not greater than 1 mm. The flow channel C and the flow channel structure including the flow channel C may be made of a material such as plastic or glass.

The biological sample analyzer of the present disclosure is designed so that the biological sample flowing in the flow channel C, or particularly, the biological particles in the biological sample are irradiated with light from the light irradiation unit 6101. The biological sample analyzer of the present disclosure may be designed so that the irradiation point of light on the biological sample is located in the flow channel structure in which the flow channel C is formed, or may be designed so that the irradiation point is located outside the flow channel structure. An example of the former case may be a configuration in which the light is emitted onto the flow channel C in a microchip or a flow cell. In the latter case, the biological particles after exiting the flow channel structure (particularly, the nozzle portion thereof) may be irradiated with the light, and a flow cytometer of a jet-in-air type can be adopted, for example.

### (Light Irradiation Unit)

The light irradiation unit 6101 includes a light source unit that emits light, and a light guide optical system that guides the light to the irradiation point. The light source unit includes one or more light sources. The type of the light source(s) is a laser light source or an LED, for example. The wavelength of light to be emitted from each light source may be any wavelength of ultraviolet light, visible light, and infrared light. The light guide optical system includes optical components such as beam splitters, mirrors, or optical fibers, for example. The light guide optical system may also include a lens group for condensing light, and includes an objective lens, for example. There may be one or more irradiation points at which the biological sample and light intersect. The light irradiation unit 6101 may be designed to collect light emitted onto one irradiation point from one light source or different light sources.

### (Detection Unit)

The detection unit 6102 includes at least one photodetector that detects light generated by emitting light onto biological particles. The light to be detected may be fluorescence or scattered light (such as one or more of the following: forward scattered light, backscattered light, and side scattered light), for example. Each photodetector includes one or more light receiving elements, and has a light receiving element array, for example. Each photodetector may include one or more photomultiplier tubes (PMTs) and/or photodiodes such as APDs and MPPCs, as the light receiving elements. The photodetector includes a PMT array in which a plurality of PMTs is arranged in a one-dimensional direction, for example. The detection unit 6102 may also include an image sensor such as a CCD or a CMOS. With the image sensor, the detection unit 6102 can acquire an image (such as a bright-field image, a dark-field image, or a fluorescent image, for example) of biological particles.

The detection unit 6102 includes a detection optical system that causes light of a predetermined detection wavelength to reach the corresponding photodetector. The detection optical system includes a spectroscopic unit such as a prism or a diffraction grating, or a wavelength separation unit such as a dichroic mirror or an optical filter. The detection optical system is designed to disperse the light generated by light irradiation to biological particles, for example, and detect the dispersed light with a larger number of photodetectors than the number of fluorescent dyes with which the biological particles are labeled. A flow cytometer including such a detection optical system is called a spectral flow cytometer. Further, the detection optical system is designed to separate the light corresponding to the fluorescence wavelength band of a specific fluorescent dye from the light generated by the light irradiation to the biological particles, for example, and cause the corresponding photodetector to detect the separated light.

The detection unit 6102 may also include a signal processing unit that converts an electrical signal obtained by a photodetector into a digital signal. The signal processing unit may include an A/D converter as a device that performs the conversion. The digital signal obtained by the conversion performed by the signal processing unit can be transmitted to the information processing unit 6103. The digital signal can be handled as data related to light (hereinafter, also referred to as “light data”) by the information processing unit 6103. The light data may be light data including fluorescence data, for example. More specifically, the light data may be data of light intensity, and the light intensity may be light intensity data of light including fluorescence (the light intensity data may include feature quantities such as area, height, and width).

### (Information Processing Unit)

The information processing unit 6103 includes a processing unit that performs processing of various kinds of data (light data, for example), and a storage unit that stores various kinds of data, for example. In a case where the processing unit acquires the light data corresponding to a fluorescent dye from the detection unit 6102, the processing unit can perform fluorescence leakage correction (a compensation process) on the light intensity data. In the case of a spectral flow cytometer, the processing unit also performs a fluorescence separation process on the light data, and acquires the light intensity data corresponding to the fluorescent dye. The fluorescence separation process may be performed by an unmixing method disclosed in JP 2011-232259 A, for example. In a case where the detection unit 6102 includes an image sensor, the processing unit may acquire morphological information about the biological particles, on the basis of an image acquired by the image sensor. The storage unit may be designed to be capable of storing the acquired light data. The storage unit may be designed to be capable of further storing spectral reference data to be used in the unmixing process.

In a case where the biological sample analyzer 6100 includes the sorting unit 6104 described later, the information processing unit 6103 can determine whether to sort the biological particles, on the basis of the light data and/or the morphological information. The information processing unit 6103 then controls the sorting unit 6104 on the basis of the result of the determination, and the biological particles can be sorted by the sorting unit 6104.

The information processing unit 6103 may be designed to be capable of outputting various kinds of data (such as light data and images, for example). For example, the information processing unit 6103 can output various kinds of data (such as a two-dimensional plot or a spectrum plot, for example) generated on the basis of the light data. The information processing unit 6103 may also be designed to be capable of accepting inputs of various kinds of data, and accepts a gating process on a plot by a user, for example. The information processing unit 6103 may include an output unit (such as a display, for example) or an input unit (such as a keyboard, for example) for performing the output or the input.

The information processing unit 6103 may be designed as a general-purpose computer, and may be designed as an information processing device that includes a CPU, a RAM, and a ROM, for example. The information processing unit 6103 may be included in the housing in which the light irradiation unit 6101 and the detection unit 6102 are included, or may be located outside the housing. Further, the various processes or functions to be executed by the information processing unit 6103 may be realized by a server computer or a cloud connected via a network.

### (Sorting Unit)

The sorting unit 6104 performs sorting of biological particles, in accordance with the result of determination performed by the information processing unit 6103. The sorting method may be a method by which droplets containing biological particles are generated by vibration, electric charges are applied to the droplets to be sorted, and the traveling direction of the droplets is controlled by an electrode. The sorting method may be a method for sorting by controlling the traveling direction of biological particles in the flow channel structure. The flow channel structure has a control mechanism based on pressure (injection or suction) or electric charge, for example. An example of the flow channel structure may be a chip (the chip disclosed in JP 2020-76736 A, for example) that has a flow channel structure in which the flow channel C branches into a recovery flow channel and a waste liquid flow channel on the downstream side, and specific biological particles are collected in the recovery flow channel.

In one exemplary implementation, a CNN is trained to identify and count the number of cells in each carrier in cell images. The CNN is also trained to identify secretion information in cell images. In an implementation, the CNN analyzes cell images including identifying and counting the number of cells in each carrier, and only cell images with a single cell in a carrier are analyzed based on the secretion information in the cell images. The cell images that are classified as having high secretion are retained. In another implementation, the CNN analyzes cell images based on the secretion information in the cell images. The cell images that are determined to have high secretion are then analyzed and the number of cells in each carrier are counted, and only the cell images with a single cell in a carrier are retained. In another example, the cell count analysis and the secretion analysis occur in parallel.

To utilize the cell enumeration described herein, devices such as a microscope with a camera are used to acquire content, and a device is able to process the acquired content. The cell enumeration is able to be implemented with user assistance or automatically without user involvement.

In operation, the cell enumeration is used to count the number of cells in a carrier. The ability to count the number of cells in a carrier from a brightfield image ensures that a sorted product will have the desired number of cells. Additionally, being able to exclude events with multiple cells will greatly increase the efficiency of the experiments because the carriers can be seeded at a greater density which will result in a greater percentage (e.g., approximately 40%) of carriers that contain the desired number of cells.

### SOME EMBODIMENTS OF CELL ENUMERATION MODULE FOR SECRETION SORTING

1. A method comprising:
   receiving a plurality of cell images, wherein each cell image of the plurality of cell images contains a carrier;
   counting a number of cells in each carrier in each cell image of the plurality of cell images;
   classifying each of the cell images based on the number of cells in each carrier; and
   classifying each of the cell images based on detected secretion information.
2. The method of clause 1 wherein the plurality of cell images are brightfield images.
3. The method of clause 1 further comprising training a neural network to classify cell images based on counting the number of cells in each carrier, and training the neural network to classify the cell images based on secretion information.
4. The method of clause 1 further comprising retaining only the cell images classified as having a single cell in each carrier.
5. The method of clause 1 wherein classifying each of the cell images based on the detected secretion information includes a “no secretion” classification, a “low secretion” classification, and a “high secretion” classification.
6. The method of clause 1 wherein classifying each of the cell images based on the detected secretion information includes retaining only images with a “high secretion” classification.
7. The method of clause 1 wherein classifying each of the cell images based on the number of cells in each carrier and classifying each of the cell images based on the detected secretion information occur in parallel.
8. The method of clause 1 wherein the carrier comprises a double emulsion.
9. An apparatus comprising:
   a non-transitory memory for storing an application, the application for:
      receiving a plurality of cell images, wherein each cell image of the plurality of cell images contains a carrier;
      counting a number of cells in each carrier in each cell image of the plurality of cell images;
      classifying each of the cell images based on the number of cells in each carrier; and classifying each of the cell images based on detected secretion information; and
   a processor coupled to the memory, the processor configured for processing the application.
10. The apparatus of clause 9 wherein the plurality of cell images are brightfield images.
11. The apparatus of clause 9 wherein the application is further for training a neural network to classify cell images based on counting the number of cells in each carrier, and training the neural network to classify the cell images based on secretion information.
12. The apparatus of clause 9 wherein the application is further for retaining only the cell images classified as having a single cell in each carrier.
13. The apparatus of clause 9 wherein classifying each of the cell images based on the detected secretion information includes a “no secretion” classification, a “low secretion” classification, and a “high secretion” classification.
14. The apparatus of clause 9 wherein classifying each of the cell images based on the detected secretion information includes retaining only images with a “high secretion” classification.
15. The apparatus of clause 9 wherein classifying each of the cell images based on the number of cells in each carrier and classifying each of the cell images based on the detected secretion information occur in parallel.
16. The apparatus of clause 9 wherein the carrier comprises a double emulsion.
17. A system comprising:
   a first device configured for acquiring a plurality of cell images; and
   a second device configured for:
      receiving a plurality of cell images, wherein each cell image of the plurality of cell images contains a carrier;
      counting a number of cells in each carrier in each cell image of the plurality of cell images;
      classifying each of the cell images based on the number of cells in each carrier; and
      classifying each of the cell images based on detected secretion information.
18. The system of clause 17 wherein the plurality of cell images are brightfield images.
19. The system of clause 17 wherein the second device is further for training a neural network to classify cell images based on counting the number of cells in each carrier, and training the neural network to classify the cell images based on secretion information.
20. The system of clause 17 wherein the second device is further for retaining only the cell images classified as having a single cell in each carrier.
21. The system of clause 17 wherein classifying each of the cell images based on the detected secretion information includes a “no secretion” classification, a “low secretion” classification, and a “high secretion” classification.
22. The system of clause 17 wherein classifying each of the cell images based on the detected secretion information includes retaining only images with a “high secretion” classification.
23. The system of clause 17 wherein classifying each of the cell images based on the number of cells in each carrier and classifying each of the cell images based on the detected secretion information occur in parallel.
24. The system of clause 17 wherein the carrier comprises a double emulsion.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method comprising:
receiving a plurality of cell images, wherein each cell image of the plurality of cell images contains a carrier;
counting a number of cells in each carrier in each cell image of the plurality of cell images;
classifying each of the cell images based on the number of cells in each carrier; and
classifying each of the cell images based on detected secretion information.

2. The method of claim 1 wherein the plurality of cell images are brightfield images.

3. The method of claim 1 further comprising training a neural network to classify cell images based on counting the number of cells in each carrier, and training the neural network to classify the cell images based on secretion information.

4. The method of claim 1 further comprising retaining only the cell images classified as having a single cell in each carrier.

5. The method of claim 1 wherein classifying each of the cell images based on the detected secretion information includes a “no secretion” classification, a “low secretion” classification, and a “high secretion” classification.

6. The method of claim 1 wherein classifying each of the cell images based on the detected secretion information includes retaining only images with a “high secretion” classification.

7. The method of claim 1 wherein classifying each of the cell images based on the number of cells in each carrier and classifying each of the cell images based on the detected secretion information occur in parallel.

8. The method of claim 1 wherein the carrier comprises a double emulsion.

9. An apparatus comprising:
a non-transitory memory for storing an application, the application for:
receiving a plurality of cell images, wherein each cell image of the plurality of cell images contains a carrier;
counting a number of cells in each carrier in each cell image of the plurality of cell images;
classifying each of the cell images based on the number of cells in each carrier; and
classifying each of the cell images based on detected secretion information; and
a processor coupled to the memory, the processor configured for processing the application.

10. The apparatus of claim 9 wherein the plurality of cell images are brightfield images.

11. The apparatus of claim 9 wherein the application is further for training a neural network to classify cell images based on counting the number of cells in each carrier, and training the neural network to classify the cell images based on secretion information.

12. The apparatus of claim 9 wherein the application is further for retaining only the cell images classified as having a single cell in each carrier.

13. The apparatus of claim 9 wherein classifying each of the cell images based on the detected secretion information includes a “no secretion” classification, a “low secretion” classification, and a “high secretion” classification.

14. The apparatus of claim 9 wherein classifying each of the cell images based on the detected secretion information includes retaining only images with a “high secretion” classification.

15. The apparatus of claim 9 wherein classifying each of the cell images based on the number of cells in each carrier and classifying each of the cell images based on the detected secretion information occur in parallel.

16. The apparatus of claim 9 wherein the carrier comprises a double emulsion.

17. A system comprising:
a first device configured for acquiring a plurality of cell images; and
a second device configured for:
receiving a plurality of cell images, wherein each cell image of the plurality of cell images contains a carrier;
counting a number of cells in each carrier in each cell image of the plurality of cell images;
classifying each of the cell images based on the number of cells in each carrier; and
classifying each of the cell images based on detected secretion information.

18. The system of claim 17 wherein the plurality of cell images are brightfield images.

19. The system of claim 17 wherein the second device is further for training a neural network to classify cell images based on counting the number of cells in each carrier, and training the neural network to classify the cell images based on secretion information.

20. The system of claim 17 wherein the second device is further for retaining only the cell images classified as having a single cell in each carrier.

21. The system of claim 17 wherein classifying each of the cell images based on the detected secretion information includes a “no secretion” classification, a “low secretion” classification, and a “high secretion” classification.

22. The system of claim 17 wherein classifying each of the cell images based on the detected secretion information includes retaining only images with a “high secretion” classification.

23. The system of claim 17 wherein classifying each of the cell images based on the number of cells in each carrier and classifying each of the cell images based on the detected secretion information occur in parallel.

24. The system of claim 17 wherein the carrier comprises a double emulsion.
